(19) United States
(12) Patent Application Publication
(10) Pub. No.: US 2024/0364067 A1
(43) Pub. Date: Oct. 31, 2024

(54) CONNECTOR MANUFACTURING APPARATUS

(71) Applicant: Yazaki Corporation, Tokyo (JP)

(72) Inventors: Naoki KOBAYASHI, Makinohara-shi (JP); Masaki TANAKA, Makinohara-shi (JP); Jun ISHIKAWA, Tokyo (JP)

(73) Assignee: Yazaki Corporation, Tokyo (JP)

(21) Appl. No.: 18/629,383

(22) Filed: Apr. 8, 2024

(30) Foreign Application Priority Data
Apr. 26, 2023 (JP) 2023-072378

(51) Int. Cl. H01R 43/20

(52) U.S. Cl. CPC H01R 43/20; H01R 2201/26

(57) ABSTRACT

A connector manufacturing apparatus for manufacturing a connector that includes a busbar and a housing, wherein the connector manufacturing apparatus comprises a press-fit jig, the busbar includes a pair of connected bodies and a pair of coupling portion that couple the pair of connected bodies, the pair of coupling portions is provided at both end portions of the pair of connected bodies, each of the pair of coupling portions includes a pair of extended portions each extending on a same plane as the base portion of a corresponding one of the pair of connected bodies and a continuous portion that is continuous to both of the pair of extended portions and provided between the extended portions, the continuous portion is configured to be bent at a boundary portion with each of the extended portions, the press-fit jig is provided in a plate shape enterable between the extended portions constituting the pair, the press-fit jig includes a first surface, a second surface, and a third surface, and when the press-fit jig enters between the extended portions constituting the pair, the first surface is in contact with the continuous portion, the second surface is in contact with the one of the pair of extended portions, and the third surface is in contact with the other of the pair of extended portions.

### TECHNICAL FIELD

The present invention relates to a connector manufacturing apparatus.

### BACKGROUND

Automobiles are equipped with a wide variety of electronic devices, and wire harnesses are routed to transmit power, control signals, and the like to the electronic devices. A wire harness is equipped with multiple electric wires and connectors, and is connected to an electronic device or another wire harness by fitting this connector to the connector of the electronic device or the another wire harness (for example, see Patent Document 1).

Patent Document 1 discloses a joint connector. A joint connector disclosed in Patent Document 1 joins, for example, multiple electric wires extending from respective electric systems provided on the driver's seat side of an automobile or the like, and electrically connects the joined electric wires to a ground electric wire extending from the engine compartment side, and includes a connector housing and a busbar housed in the connector housing.

The connector housing includes multiple terminals containing portions that contain and hold connection terminals crimped and connected to electric wires extending from various kinds of electric systems equipped on the driver's seat side. The connector housing is provided with insertion ports through which the tab terminals connected to the connection terminals are inserted into the respective terminal-containing portions.

The busbar includes multiple tab terminals provided side by side in association with the arrangement of the insertion ports of the connector housing, and a fixation plate portion serving as a portion for fixation to a target structure such as a vehicle body or the like.

In such a joint connector, by pressing in the busbar while the tab terminals are brought closer to the insertion ports of the respective terminal-containing portions, the tab terminals are contained in the respective terminal-containing portions.

### RELATED ART

### Patent Document

Patent Document 1: JPH07-161419 (A)

### SUMMARY OF THE INVENTION

### Problem to be Solved by the Invention

However, in the conventional joint connector, by pressing in the busbar, the respective tab terminals are contained in the respective terminal-containing portions, but there was a concern that, depending on the load during pressing in, the tab terminals may be warped and deformed.

It is an object of the present invention to provide a connector manufacturing apparatus that alleviates deformation of the tab terminals.

### Solution to Problem

In order to solve the above problems and achieve the object, according to an aspect of the present invention, a connector manufacturing apparatus for manufacturing a connector includes a busbar including tab terminals and a housing including terminal-containing portions containing the respective tab terminals, wherein the connector manufacturing apparatus comprises a press-fit jig for pressing the busbar into the housing to contain the tab terminals in the terminal-containing portions, the busbar includes: a pair of connected bodies that oppose each other; and a pair of coupling portions that couple the pair of connected bodies, each of the pair of connected bodies includes: the tab terminals; and a base portion provided continuously to the tab terminals and extending in a direction in which the tab terminals are arranged, the pair of coupling portions is provided at both end portions, in the direction in which the tab terminals are arranged, of the pair of connected bodies, each of the pair of coupling portions includes: a pair of extended portions each extending on a same plane as the base portion of a corresponding one of the pair of connected bodies; and a continuous portion that is continuous to both of the pair of extended portions and provided between the extended portions, the continuous portion is configured to be bent at a boundary portion with each of the extended portions, the press-fit jig is provided in a plate shape enterable between the extended portions, the press-fit jig includes: a first surface capable of coming into contact with the continuous portion: a second surface continuous to one end of the first surface; and a third surface continuous to the other end of the first surface, and wherein when the press-fit jig enters between the extended portions, the first surface is in contact with the continuous portion, the second surface is in contact with one of the extended portions, and the third surface is in contact with the other of the extended portions.

### Advantageous Effects of the Invention

According to an aspect of the present invention, deformation of the tab terminals can be alleviated.

### BRIEF DESCRIPTION OF THE DRAWINGS

FIG. 1 is a perspective view illustrating a connector constituting a connector manufacturing apparatus according to an embodiment of the present invention.

FIG. 2 is an exploded perspective view illustrating the connector.

FIG. 3 is a plan view for explaining how the connector is assembled using a press-fit jig constituting the connector manufacturing apparatus.

FIG. 4 is a cross-sectional view taken along line I-I of FIG. 3.

FIG. 5 is a cross-sectional view illustrating the connector of FIG. 4 in an assembled state with the press-fit jig being pulled out.

FIG. 6 is a view for explaining a comparative example of the present embodiment.

### DETAILED DESCRIPTION OF THE EXEMPLARY EMBODIMENT

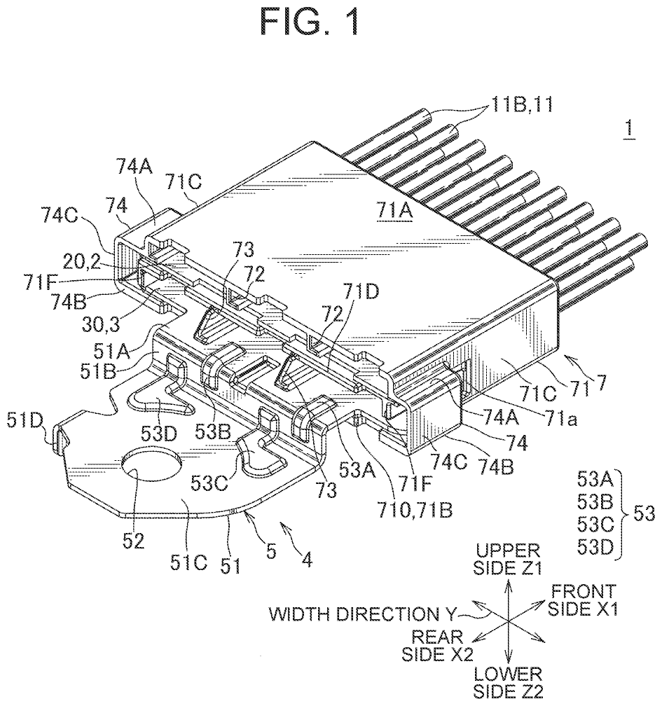

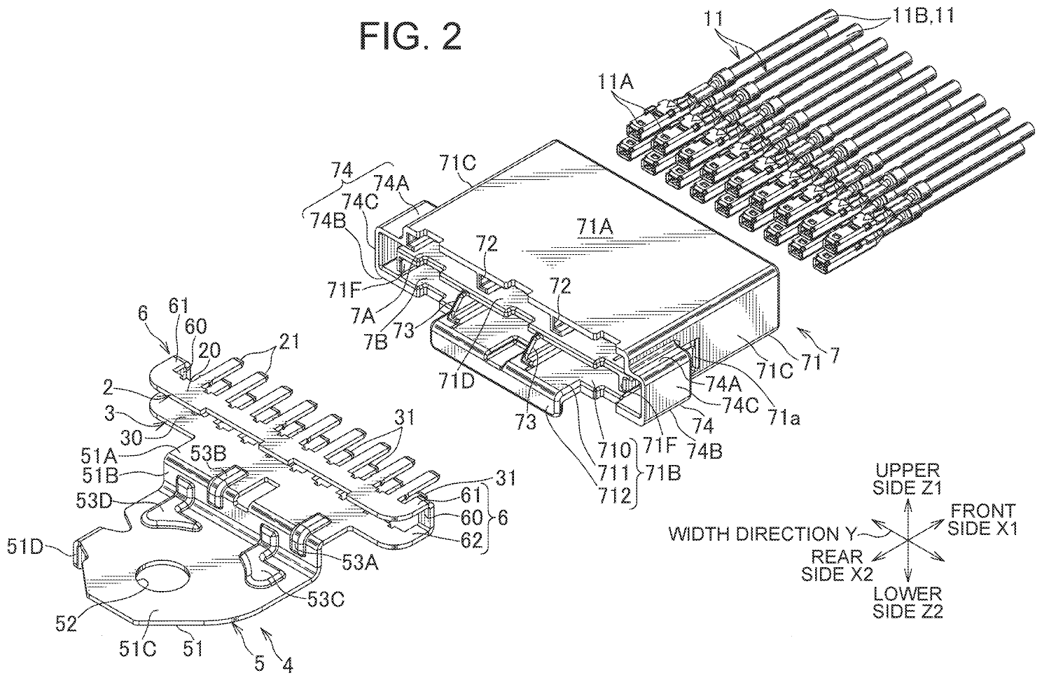

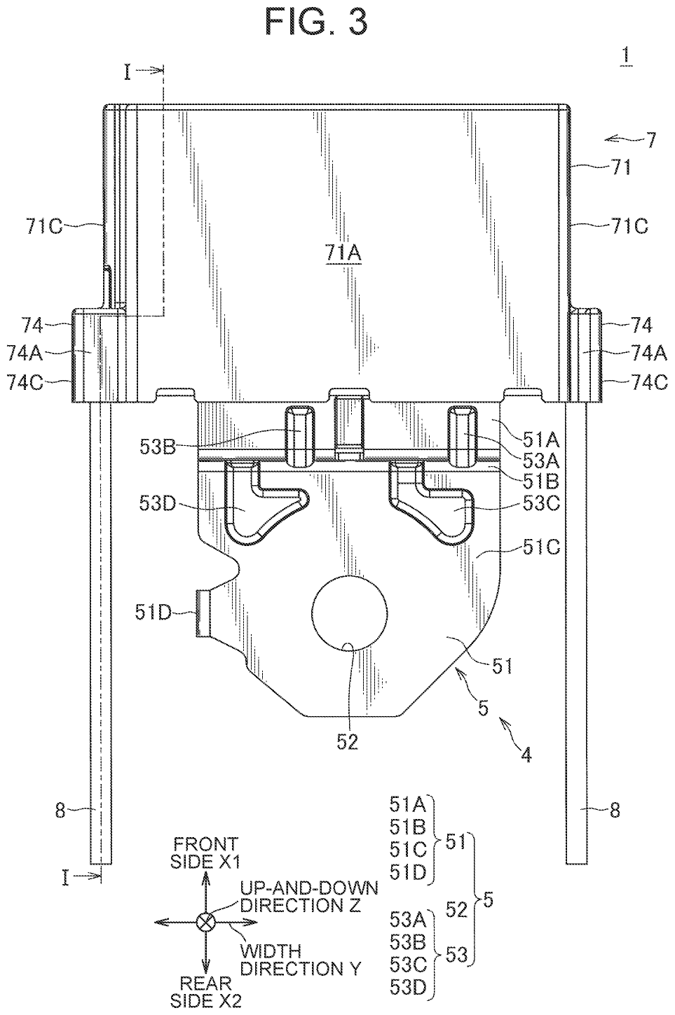

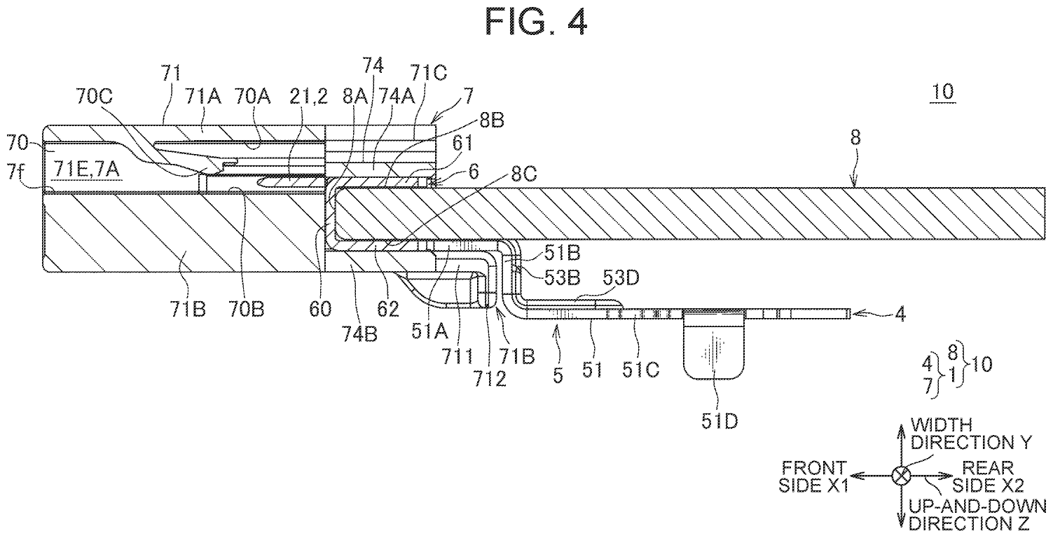

Hereinafter, an embodiment of the present invention is described with reference to FIGS. 1 to 6. FIG. 1 is a perspective view illustrating a connector 1 constituting a connector manufacturing apparatus 10 according to an embodiment of the present invention. FIG. 2 is an exploded perspective view illustrating the connector 1. FIG. 3 is a plan view for explaining how the connector 1 is assembled using press-fit jigs 8 constituting the connector manufacturing apparatus 10. FIG. 4 is a cross-sectional view taken along line I-I of FIG. 3.

As illustrated in FIGS. 1, 2, and 4, the connector manufacturing apparatus 10 according to an embodiment of the present invention is to manufacture the connector 1, and includes a pair of press-fit jigs 8, 8 (as illustrated in FIG. 4) for pressing a busbar 4 having multiple tab terminals 21, 31 (illustrated in FIG. 2) into the housing 7 to cause the respective tab terminals 21, 31 to be contained in respective terminal-containing portions 70 (as illustrated in FIG. 4).

The connector 1 is manufactured with the press-fit jigs 8 explained later, and as illustrated in FIGS. 1 to 4, and includes the busbar 4 including the multiple tab terminals 21, 31 (illustrated in FIG. 2), and the housing 7 including the multiple terminal-containing portions 70 (illustrated in FIG. 4) containing the respective multiple tab terminals 21, 31. As illustrated in FIG. 2, in the connector 1, terminal-attached electric wires 11 are connected to the respective multiple tab terminals 21, 31, which are in turn fixed to a vehicle body panel, not illustrated, so that electric currents passing through the terminal-attached electric wires 11 are grounded. Each of the terminal-attached electric wires 11 includes a terminal metal fitting (which may be hereinafter referred to as a female terminal 11A) of a female type connected to the respective tab terminals 21, 31 and an electric wire 11B connected to the female terminal 11A.

As illustrated in FIGS. 1, 2, the busbar 4 includes an upper side connected body 2, a lower side connected body 3, a vehicle body fixation portion 5 provided continuously to the lower side connected body 3 and fixed to the vehicle body panel, and a pair of coupling portions 6, 6 (illustrated in FIG. 2) provided between and continuous to the upper side connected body 2 and the lower side connected body 3.

In the present embodiment, an X direction (front-and-back direction), a Y direction (width direction, a direction in which the tab terminals 21, 31 are arranged), and a Z direction (up-and-down direction) are direction perpendicular to each other. A direction in which the tab terminals 21, 31 extend may be referred to as “front side (X1 direction)”, and a direction opposite thereto may be referred to as a “rear side (X2 direction)”. A direction in which the upper side connected body 2 and the lower side connected body 3 oppose each other may be referred to as an “up-and-down direction (Z direction)”, one side in the Z direction (side of the upper side connected body 2) may be referred to as an “upper side (Z1 direction)”, and the other side in the Z direction (side of the lower side connected body 3) may be referred to as a “lower side (Z2 direction)”.

As illustrated in FIG. 2, the upper side connected body 2 includes an upper side base portion 20 (base portion) in a rectangular shape extending in the width direction Y and upper side tab terminals 21 (tab terminals) extending from the upper side base portion 20 to the front side X1.

As illustrated in FIG. 2, the lower side connected body 3 includes a lower side base portion 30 (base portion) in a rectangular shape extending in the width direction Y and lower side tab terminals 31 (tab terminals) extending from the lower side base portion 30 to the front side X1.

As illustrated in FIGS. 1, 2, the vehicle body fixation portion 5 includes a vehicle body fixation portion main body 51 continuous to the rear side X2 of the lower side connected body 3, a bolt insertion hole 52 in which a stud bolt, not illustrated, protruding from the vehicle body panel is inserted, and multiple (four) embossed portions 53 provided on the vehicle body fixation portion main body 51.

As illustrated in FIG. 2, the vehicle body fixation portion main body 51 includes a first plate-shaped portion 51A continuous to the rear side X2 of the lower side connected body 3, a second plate-shaped portion 51B continuous to the rear side X2 of the first plate-shaped portion 51A and bent to extend to the lower side Z2, a third plate-shaped portion 51C continuous to the lower end of the second plate-shaped portion 51B and bent to extend to the rear side X2, and a fourth plate-shaped portion 51D bent from the third plate-shaped portion 51C and extending to the lower side Z2.

As illustrated in FIG. 2, the first plate-shaped portion 51A is provided in a rectangular plate shape and is provided in a central portion, in the width direction Y, of the lower side base portion 30 of the lower side connected body 3. The first plate-shaped portion 51A is provided on the same plane as lower side base portion 30 of the lower side connected body 3.

As illustrated in FIG. 2, the third plate-shaped portion 51C is provided opposite to the first plate-shaped portion 51A, and is provided opposite to the vehicle body panel.

As illustrated in FIG. 2, the fourth plate-shaped portion 51D is provided continuous to an edge, in the width direction Y, of the third plate-shaped portion 51C, and is provided to be bent from the third plate-shaped portion 51C and extend to the lower side Z2. This fourth plate-shaped portion 51D is configured to be inserted into a slit (not illustrated) provided in the vehicle body panel.

The bolt insertion hole 52 is provided in the central portion of the third plate-shaped portion 51C to penetrate the third plate-shaped portion 51C, and is configured to allow a stud bolt (not illustrated) protruding from the vehicle body panel to be inserted therethrough.

As illustrated in FIGS. 1, 2, multiple (four) embossed portions 53 include a pair of first embossed portions 53A, 54B and a pair of second embossed portions 53C, 54D.

The first embossed portions 53A, 54B, constituting the pair, are arranged side by side in the width direction Y of the vehicle body fixation portion main body 51. The first embossed portions 53A, 54B are arranged in a rectangular shape as seen from the upper side Z1, and are provided continuously from the first plate-shaped portion 51A to the second plate-shaped portion 51B.

The second embossed portions 53C, 54D, constituting the pair, are arranged side by side in the width direction Y, and are provided at positions that are on the rear side X2 of the pair of first embossed portions 53A, 54B and that are shifted toward one side in the width direction Y. The second embossed portions 53C, 54D are provided continuously from the second plate-shaped portion 51B to the third plate-shaped portion 51C.

As illustrated in FIG. 2, the coupling portions 6, 6, constituting the pair, are provided on both end portions, in the width direction Y, of the upper side connected body 2 and the lower side connected body 3. Each of the coupling portions 6 is formed in a substantially C-shape, and includes a coupling portion main body 60 (continuous portion) extending in the up-and-down direction Z, an upper side continuous plate 61 (one of extended portions constituting the pair) continuous to the coupling portion main body 60 and bent to extend to the rear side X2, and a lower side continuous plate 62 (the other of extended portions constituting the pair) continuous to the coupling portion main body 60 and bent to extend to the rear side X2. The upper side continuous plate 61 is provided continuously on the same plane as the upper side base portion 20 of the upper side connected body 2, and the lower side continuous plate 62 is provided continuously on the same plane as the lower side base portion 30 of the lower side connected body 3.

In order to manufacture the busbar 4, as illustrated in FIG. 2, after a metal plate has been embossed and punched to form a punched member (not illustrated), the boundary position between the coupling portion main body 60 and the upper side continuous plate 61 of the coupling portion 6 is bent, and the boundary position between the coupling portion main body 60 and the lower side continuous plate 62 of the coupling portion 6 is bent, so that the upper side connected body 2 and the lower side connected body 3 oppose each other. Furthermore, the boundary position between the first plate-shaped portion 51A and the second plate-shaped portion 51B is bent, and the boundary position between the second plate-shaped portion 51B and the third plate-shaped portion 51C is bent, so that the first plate-shaped portion 51A and the third plate-shaped portion 51C oppose each other. Thus, the busbar 4 is manufactured. In other words, the busbar 4 is formed by embossing and punching a metal plate. When the busbar 4 is seen from the upper side Z1, the upper side tab terminals 21 of the upper side connected body 2 and the lower side tab terminals 31 of the lower side connected body 3 are arranged alternately in the width direction Y.

The housing 7 is made of, for example, insulating resin. As illustrated in FIGS. 1, 2, this housing 7 includes a housing body 71 formed in a square tube shape with X as the front-and-back direction X being the axis, a pair of upper side support pieces 72, 72 provided on the housing body 71 to support the upper side connected body 2, a pair of lower side support pieces 73, 73 provided on the housing body 71 to support the lower side connected body 3, and a pair of C-shaped containing portions 74, 74 provided to protrude in a C-shape on either side, in the width direction Y, of the housing body 71 to contain the pair of coupling portions 6, 6 of the busbar 4.

As illustrated in FIGS. 1, 2, the housing body 71 includes an upper wall 71A, a lower wall 71B, and a pair of side walls 71C, 71C, and is configured in square tube shape. The internal space of the housing body 71 is formed to be separated by an up-and-down partition wall 71D into an upper side connected body containing portion 7A for containing the upper side connected body 2 and a lower side connected body containing portion 7B for containing the lower side connected body 3.

As illustrated in FIG. 4, each of the upper side connected body containing portion 7A and the lower side connected body containing portion 7B includes the multiple terminal-containing portions 70 for containing the tab terminals 21, 31. Each of the terminal-containing portions 70 is formed to be separated by a width-direction partition wall 71E provided on the front side X1, in the width direction Y, of the connected body containing portions 7A, 7B.

In each of the terminal-containing portions 70, the front side X1 and the rear side X2 are open, and the tab terminals 21, 31 are inserted through a rear side opening portion (not illustrated), while mating female terminals 11A that mate with the corresponding tab terminals 21, 31 are received through a front side opening portion 7f (illustrated in FIG. 4), so that the tab terminals 21, 31 and the female terminals 11A are electrically connected. As illustrated in FIG. 4, the terminal-containing portions 70 include upper surfaces 70A and bottom surfaces 70B opposing each other in the up-and-down direction Z. The terminal-containing portions 70 are provided with lances 70C for retaining the female terminals 11A. The lances 70C are continuous to the upper surfaces 70A of the respective terminal-containing portions 70 and are formed to extend toward the rear side X2.

Furthermore, as illustrated in FIG. 2, the housing body 71 includes notch portions 71a formed by cutting the front edges of the side walls 71C in a rectangular shape and a pair of separation walls 71F, 71F extending to the lower side Z2 from both ends, in the width direction Y, of the up-and-down partition wall 71D. This separation wall 71F separates the lower side connected body containing portion 7B and the C-shaped containing portions 74 explained later.

As illustrated in FIG. 2, the lower wall 71B includes a lower wall body 710 opposing the upper wall 71A, a rear side extension wall 711 extending from the lower wall body 710 toward the rear side X2, and a lower side extension wall 712 continuous to the rear side extension wall 711 and formed to extend toward the lower side Z2. While the busbar 4 is contained in the housing 7, the rear side extension wall 711 is provided to oppose the first plate-shaped portion 51A of the busbar 4, and the lower side extension wall 712 is provided to oppose the second plate-shaped portion 51B of the busbar 4.

The upper side support pieces 72, 72 constituting the pair are provided spaced part from each other in the width direction Y. The upper side support pieces 72 are provided to protrude from the upper wall 71A to the lower side Z2, and with the busbar 4 being contained in the housing 7, the upper side support pieces 72 are configured to come into contact with the upper side base portion 20 of the upper side connected body 2 to press the upper side connected body 2 against the up-and-down partition wall 71D.

In the width direction Y, the pair of lower side support pieces 73, 73 are situated at the same positions are the pair of upper side support pieces 72, 72. The lower side support pieces 73 are provided to protrude from the up-and-down partition wall 71D toward the lower side Z2 and the rear side X2, and with the busbar 4 being contained in the housing 7, the lower side support pieces 73 are configured to come into contact with the lower side base portion 30 of the lower side connected body 3 and the first plate-shaped portion 51A to press the lower side connected body 3 against the lower wall 71B.

The pair of C-shaped containing portions 74, 74 is provided on either side, in the width direction Y, of the housing body 71, and is provided to protrude in the width direction Y from the housing body 71. The C-shaped containing portion 74 includes a first wall 74A and a second wall 74B opposing each other in the up-and-down direction Z and a third wall 74C continuous to the first wall 74A and the second wall 74B, and is configured in a C-shape. The first wall 74A and the second wall 74B are provided to protrude, on each of the side walls 71C of the housing body 71, from positions including the notch portions 71a (a position on the upper side Z1 with respect to the notch portion 71a, and a position on the lower side Z2 with respect to the notch portion 71a).

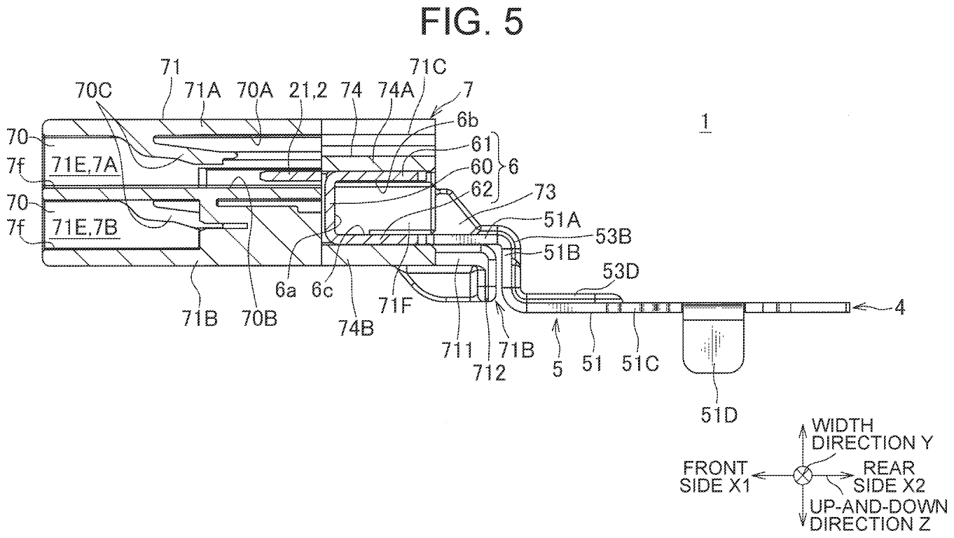

As illustrated in FIGS. 3, 4, the press-fit jigs 8 are formed in a square columnar shape and are configured to be enterable into the inside of the C-shaped containing portion 74. As illustrated in FIGS. 4, 5, the press-fit jigs 8 are provided with a jig end face 8A capable of coming into contact with an inner surface 6a (illustrated in FIG. 4) of the coupling portion main body 60, a jig upper surface 8B capable of coming into contact with an inner surface 6b (illustrated in FIG. 4) of the upper side continuous plate 61, and a jig lower surface 8C capable of coming into contact with an inner surface 6c (illustrated in FIG. 4) of the lower side continuous plate 62 of the corresponding coupling portion 6. The jig end face 8A is constituted by a flat surface extending in the up-and-down direction Z and the width direction Y, and the jig upper surface 8B and the jig lower surface 8C are constituted by a flat surface extending in the front-and-back direction X and the width direction Y. Next, a procedure for manufacturing the connector 1 using the pair of press-fit jigs 8, 8 is explained with reference to FIGS. 3 to 5.

First, as illustrated in FIG. 3, the tips of the tab terminals 21, 31 of the busbar 4 are brought closer to and inserted into the rear side opening portions of the respective terminal-containing portions 70 of the housing 7. Also, the coupling portions 6 of the busbar 4 are brought closer to and inserted into the pair of C-shaped containing portions 74, 74 of the housing 7. Thereafter, each of the press-fit jigs 8 constituting the pair is brought closer to and simultaneously moved to between the upper side continuous plate 61 and the lower side continuous plate 62 of the coupling portion 6. As illustrated in FIG. 4, the jig end faces 8A of the respective press-fit jigs 8 come into contact with the inner surfaces 6a of the coupling portion main bodies 60 of the respective coupling portions 6 of the busbar 4, the jig upper surfaces 8B come into contact with the inner surfaces 6b of the upper side continuous plates 61 of the respective coupling portions 6, and the jig lower surfaces 8C come into contact with the inner surfaces 6c of the lower side continuous plates 62 of the respective coupling portions 6. While the jig end face 8A, the jig upper surface 8B, jig lower surface 8C of the respective press-fit jigs 8 and the inner surface 6a, 6b, 6c of the respective coupling portions 6 are in contact, the press-fit jigs 8 further move to cause the tab terminals 21, 31 to reach the predetermined positions of the terminal-containing portions 70, so that the tab terminals 21, 31 are contained in the respective terminal-containing portions 70 (illustrated in FIG. 5). Also, the upper side connected body 2 is contained in the upper side connected body containing portion 7A, the lower side connected body 3 is contained in the lower side connected body containing portion 7B. Therefore, the press-fit jigs 8 are withdrawn from between the upper side continuous plate 61 and the lower side continuous plate 62 of the coupling portion 6. The connector 1 is thus assembled.

Thereafter, the female terminals 11A of the terminal-attached electric wires 11 are inserted into the terminal-containing portions 70 through the front side opening portions 7f of the housing 7, so that in the terminal-containing portions 70, the tab terminals 21, 31 and the female terminals 11A are electrically connected.

Thereafter, the vehicle body fixation portion 5 of the busbar 4 is placed to oppose a predetermined position of a vehicle body panel. A stud bolt protruding from the vehicle body panel is inserted into the bolt insertion hole 52 of the busbar 4, and the fourth plate-shaped portion 51D of the vehicle body fixation portion 5 is inserted into a slit provided in the vehicle body panel. Thereafter, a nut is fastened to the stud bolt, so that the vehicle body fixation portion 5 is fixed to the vehicle body panel. Thus, the connector 1 is fixed to the vehicle body panel. In this manner, with the connector 1 being fixed to the vehicle body panel, electric currents passing through the terminal-attached electric wires 11 are grounded to the vehicle body panel via the busbar 4.

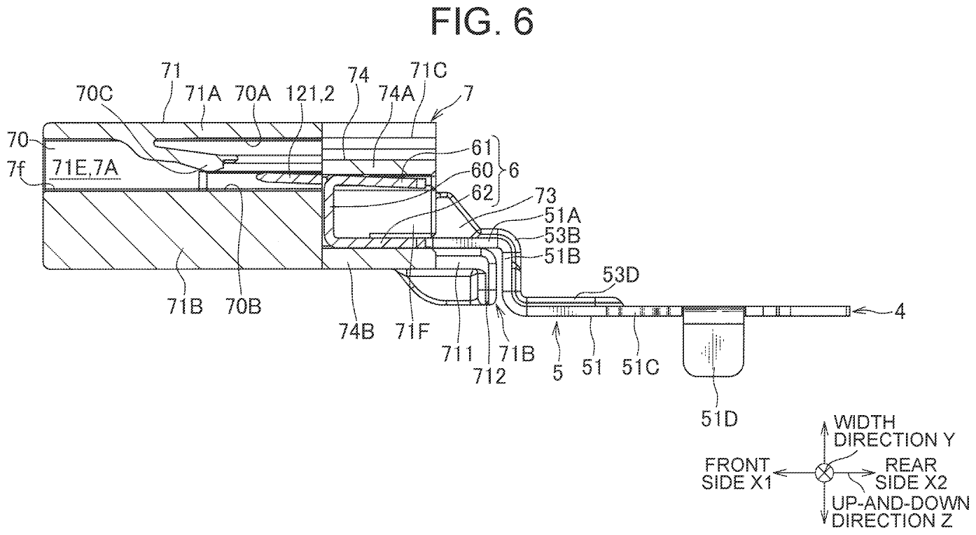

Next, actions and effects of the present embodiment are explained. FIG. 6 is a view for explaining a comparative example of the present embodiment. As illustrated in FIG. 6, when the busbar 4 is pressed into the housing 7 without using the press-fit jigs 8, in particular, the tips of the upper side tab terminals 121 are likely to be deformed to face diagonally upward. In contrast, in the present embodiment, the press-fit jigs 8 enter between the upper side continuous plate 61 and the lower side continuous plate 62 of each of the coupling portions 6, so that while a constant spacing is maintained between the upper side continuous plate 61 and the lower side continuous plate 62 of each of the coupling portions 6, the tab terminals 21, 31 are contained in the terminal-containing portions 70, and this allows the tab terminals 21, 31 to be contained in the terminal-containing portions 70 such that, as illustrated in FIG. 5, in particular, the tips of the upper side tab terminals 21 are extending straightly.

According to the above-described embodiment, the press-fit jigs 8 are formed in a plate shape enterable between the upper side continuous plate 61 and the lower side continuous plate 62 (a pair of extended portions), and includes a jig end face 8A (first surface) capable of coming into contact with the coupling portion 6, a jig upper surface 8B (second surface) continuous to one end of the jig end face 8A, and a jig lower surface 8C (third surface) continuous to the other end of the jig end face 8A, wherein while the press-fit jig 8 enters between the upper side continuous plate 61 and the lower side continuous plate 62, the jig end face 8A is in contact with the coupling portion main body 60 (continuous portion), the jig upper surface 8B is in contact with the upper side continuous plate 61 (one of extended portions constituting the pair), and the jig lower surface 8C is in contact with the lower side continuous plate 62 (the other of extended portions constituting the pair). Accordingly; the press-fit jigs 8 enter between the upper side continuous plate 61 and the lower side continuous plate 62 of each of the coupling portions 6, so that while a constant spacing is maintained between the upper side continuous plate 61 and the lower side continuous plate 62 of each of the coupling portions 6, the tab terminals 21, 31 are contained in the respective terminal-containing portions 70, which allows, in particular, the upper side tab terminals 21 to be pressed in without deformation. In other words, deformation of the tab terminals 21, 31 is alleviated.

Also, the lower side connected body 3 (the other of the connected bodies constituting the pair) is provided continuous to the base portion 30 and extends to the rear side X2 (a direction away from the tab terminals), and includes the vehicle body fixation portion 5 fixed to the vehicle body panel. In other words, in contrast to the lower side connected body 3, the upper side connected body 2 is not provided with the vehicle body fixation portion 5 and is in a cantilever manner, and therefore, the upper side base portion 20 is likely to be inclined to cause the tips of the upper side tab terminals 21 to be deformed to face diagonally upward, but by performing press-fit using the press-fit jigs 8, press-fit can be achieved without deforming, in particular, the upper side tab terminals 21.

Although the best configuration, method, and the like for carrying out the present invention are disclosed in the above description, the present invention is not limited thereto. That is, although the present invention has been particularly illustrated and described primarily with respect to the particular embodiment, it is understood that, without departing from the spirit and scope of the present invention, the present invention can be modified in various ways by those skilled in the art in terms of shape, material, quantity, and other detailed configurations of the embodiment described above. Therefore, since the descriptions that limit the shape, material, and the like disclosed above are illustrative examples to facilitate understanding of the present invention, and do not limit the present invention, a description with a name of a member, from which some or all of the limitations on the shape, material, and the like are deleted, is to be included in the present invention.

### LIST OF REFERENCE SIGNS

1 connector
10 connector manufacturing apparatus
2 upper side connected body (one of connected bodies constituting a pair)
20 upper side base portion (base portion)
21 upper side tab terminal (tab terminal)
3 lower side connected body (the other of the connected bodies constituting the pair)
30 lower side base portion (base portion)
31 lower side tab terminal (tab terminal)
4 busbar
5 vehicle body fixation portion
7 housing
70 terminal-containing portion
6, 6 a pair of coupling portions
60 coupling portion main body (continuous portion)
61 upper side continuous plate (one of extended portions constituting the pair)
62 lower side continuous plate (the other of the extended portions constituting the pair)
8 press-fit jig
8A jig end face (first surface)
8B jig upper surface (second surface)
8C jig lower surface (third surface)
Y width direction (direction in which tab terminals)

What is claimed is:

1. A connector manufacturing apparatus for manufacturing a connector that includes a busbar including tab terminals and a housing including terminal-containing portions containing the respective tab terminals,
wherein the connector manufacturing apparatus comprises a press-fit jig for pressing the busbar into the housing to contain the tab terminals in the terminal-containing portions,
the busbar includes:
a pair of connected bodies that oppose each other; and
a pair of coupling portions that couple the pair of connected bodies,
each of the pair of connected bodies includes:
the tab terminals; and
a base portion provided continuously to the tab terminals and extending in a direction in which the tab terminals are arranged,
the pair of coupling portions is provided at both end portions, in the direction in which the tab terminals are arranged, of the pair of connected bodies,
each of the pair of coupling portions includes:
a pair of extended portions each extending on a same plane as the base portion of a corresponding one of the pair of connected bodies; and
a continuous portion that is continuous to both of the pair of extended portions and provided between the extended portions,
the continuous portion is configured to be bent at a boundary portion with each of the extended portions,
the press-fit jig is provided in a plate shape enterable between the extended portions,
the press-fit jig includes:
a first surface capable of coming into contact with the continuous portion;
a second surface continuous to one end of the first surface; and
a third surface continuous to the other end of the first surface, and
wherein when the press-fit jig enters between the extended portions, the first surface is in contact with the continuous portion, the second surface is in contact with one of the extended portions, and the third surface is in contact with the other of the extended portions.

2. The connector manufacturing apparatus according to claim 1, wherein one of the pair of connected bodies includes the tab terminals and the base portion, and is provided in a cantilever manner, and
the other of the connected bodies constituting the pair includes a vehicle body fixation portion that is continuous to the base portion and extends in a direction away from the tab terminals to be fixed to a vehicle body panel.
